(19) United States
(12) Patent Application Publication
(10) Pub. No.: US 2013/0332835 A1
(43) Pub. Date: Dec. 12, 2013

(54) DYNAMIC AUDIOVISUAL BROWSER AND METHOD

(71) Applicant: Eduardo Mace, Sao Paulo (BR)

(72) Inventor: Eduardo Mace, Sao Paulo (BR)

(73) Assignee: LOG ON MULTIMÍDIA LTDA, Sao Paulo (BR)

(21) Appl. No.: 13/882,452

(22) PCT Filed: Oct. 27, 2011
(86) PCT No.: PCT/BR2011/000409

§ 371 Date: Jul. 11, 2013

(30) Foreign Application Priority Data
Oct. 29, 2010 (BR) PI 1003568-0

(51) Int. Cl. G06F 3/01

(52) U.S. Cl. CPC G06F 3/01
USPC 715/720

(57) ABSTRACT

This is an invention of computing and its applications, more specifically information systems, in the areas of user interface and interactive systems for distribution of videos and games, with applications in various segments of networking systems and tele-radio digital diffusion. Particularly, it is about to a dynamic visual browser and its method of operation, which allows users to interact with video playlists while videos are being reproduced, ensuring an individualized, intuitive, and continuous experience simulating the behavior of consumption of television content, which can be shared with other users.

### REFERENCE TO RELATED APPLICATION

This is a US national stage application based on PCT/BR2011/000409 filed Oct. 27, 2011, claiming priority to application PI 1003568-0 filed in Brazil on Oct. 29, 2010, the entire disclosures of which are hereby incorporated by reference.

### FIELD OF THE INVENTION

This invention belongs to the field of computing and its applications, more specifically information systems, in the areas of user interface and interactive systems for distribution of videos and games, with applications in various segments of networking systems and tele-radio digital diffusion. Particularly, it is about to a dynamic visual browser and its method of operation, which allows users to interact with video playlists while videos are being reproduced, ensuring an individualized, intuitive, and continuous experience simulating the behavior of consumption of television content, which can be shared with other users.

### BACKGROUND OF THE INVENTION

A browser is a computer application that enables its users to interact with virtual contents.

The first browsers contained only text, but after a while, they have been refined, incorporating images and sounds. With the advent of the Internet, the World Wide Web, the field of information has been widened.

Tim Berners-Lee, who was a pioneer in the use of hypertext as a way to share information, has created the concept and the first browser, naming the set as World Wide Web, in 1990. Since then, the development of browsers has been inseparably linked to the development of the Web itself.

The Web, however, has been really given a boost in popularity only with the introduction of the NCSA Mosaic, which was a graphical browser (in opposition to the text mode browsers) running originally on Unix, but which was also ported for the Apple Macintosh and Microsoft Windows afterwards. Version 1.0 of Mosaic was released in September 1993. Marc Andreessen, the project leader on Mosaic at NCSA, quit his position in order to create a company that would later be known as Netscape Communications Corporation. Netscape has released its flagship product, the Navigator, in October 1994, and it became the most popular browser in the following year. Microsoft, which until then had ignored the Internet, entered the fray with its Internet Explorer, hastily purchased from Spyglass Inc. This marked the beginning of the ‘Browser War’, which was the fight for the market of such applications between the giant Microsoft and the smaller company, widely responsible for popularizing the Web, Netscape.

Opera, a fast and small browser, popular especially in portable computers and some European countries, was launched in 1996 and still remains a niche product in the browser market for personal computers—or PC.

From this point on, there is a gap in the technique, when it comes to browsers which use audiovisual content, only allowing to browse videos using static elements such as text and stand still images within a HTML browser or similar, using selection techniques and text and images scrolling, all within the context of hyperlinks from a HTML browser. Even in more advanced on-demand systems, usually used on cable television, the user is not provided with the interaction with videos on-the-go for selection and use of other contents, only offering a pre-established grid, which is the same for all users.

The proposal of browsers, in general, is the simple exchange of textual information, with the purpose of research and, even when dealing with the access to audiovisual content, its task is to just play, with no management possibility, and it does not happen in an intuitive, custom, or continuous manner. It is proposed to this end, a dynamic audiovisual browser that allows users to watch, browse, navigate and interact with video playlists using unique interactions, while keeping the video playing, ensuring an individualized, intuitive, and continuous experience, emulating the behavior of consumption of television video, however, it is based on video applications instead of video channels. Navigation can be two-dimensional within an array, rather than a linear list, or can be hierarchical, within a mosaic. Matrix and mosaics may have its composition chosen by the user.

It is also proposed to associated method of reproducing each video in a successive way, in sequences within an interface in order to watch and explore them, retaining preferences, history and user-generated interactions inside the video browser. This method offers custom lists of videos for each user creating a unique consumer experience of video that can be shared with other users.

In summary, we present a browser that presents audiovisual contents emulating the behavior of a television, in an interactive way.

### ANALYSIS OF STATE OF THE ART

Extensive researches in worldwide databases and on commercial pages of the world's leading manufacturers of similar equipments demonstrate the novelty of the proposed invention and can be synthesized with the analysis of the documents listed below:

The document U.S. Pat. No. 7,130,616 describes a system and a method for providing content, management and interactivity for customer devices. The digital data based on preferences from specified users are automatically obtained and transferred. Although the protection addresses similar concepts, it is not tied to intuitive and continuous browser matrices, thus departing from the peculiarities of the proposed invention.

The U.S. Pat. No. 6,654,931 describes MPEG4 playback systems which are not simple extensions of MPEG2 playback systems, but due to the nature of the MPEG4-based object, it offers new opportunities and challenges in the synchronized management of independent objects encoded as well as the composition of the scene and presentation. Therefore, these settings allow new and enhanced multimedia services and systems. Also, MPEG4 is aimed at an advanced feature called Adaptive Audio Visual Session or MPEG-J. AAVs (i.e. MPEG-AAVs, MPEG-Java or MPEG-J), require more than just the set up, the definition of an application programming interface (A-PI) and its organization in Java packages. The concepts of mosaic are also closed. The patent describes a system that includes navigation that is restricted to the use of MPEG4, whose processing takes place with data organized on the Java platform, departing from the characteristics demonstrated by the proposed invention.

The protection U.S. Pat. No. 5,956,716 shows a video storage and retrieval system, in which video clips are stored locally and/or on a more remote location and may be requested and obtained by a user on a multimedia terminal. When the user requests a video clip, the request is processed by a primary index manager (PIM) by a Search and Recovery Unit location (SRU). Before the message is communicated to the PIM, the SRU controls check its own local storage in order to determine whether the requested video clips are available. If any of the video clips is local, the SRU forwards the request to the PIM so that it can determine the use of the specific video clip. The PIM informs the SRU where audiovisual data are stored and passes this information to a Data Interface (DSI) sequence. The ISD collects the video clips and downloads of clips to the user terminal. The user can view, copy or print the video clip as desired. In a preferred form, a delivery system for distributed video, according to the invention, provides video clips stored on the same location and/or on remote locations, which can be requested from the Internet and retrieved in multimedia from the user terminal. When the user requests a desired video clip to be shown on a Web page, the request is routed to a primary index manager (PIM). PIM attempts to locate the nearest server that contains the requested clip, provided the transfer has been completed. The system also includes means for uploading videos and the geographically diverse distribution of servers, dynamic load balancing, subscription management mechanisms and safeguard means to prevent unauthorized duplication of video clips. Such invention does not show the characteristics of continuity browser and behavior emulation for television proposed for the invention in question.

The document U.S. 2007204319 shows a browser for to be used for transferring information, with particular application in information represented by audiovisual data that facilitates and enhances transmission surveillance of information (which can be represented by a set of audio data, video data, data text or a combination of these three), allowing information to be quickly revised in order to get an overview of the information contents and allowing flexibility in how the information is reviewed. In one particular application of the invention, the audiovisual content of news programs is received from a first set of one or more sources of information (e.g. television news) and text news are acquired from a second set of one or more sources information (e.g. online news services or news services). In said application, the invention might allow the user to access television news in a random way, so that the user can move quickly between news or news programs. The invention may also allow the user to quickly find the news about a particular subject, also, when the user is watching a special report on a news program, the invention can identify and display the related news. The invention can also enable the user to control the display of news programs, for example, accelerating the display, making a short story of one or more news to display, or pause the display of news. Moreover, the invention can tell the user what news is being displayed as well as stories that have been seen. Such invention does not claim any two-dimensional or intuitive browser method, departing from the protection features proposed.

### BRIEF DESCRIPTION OF THE FIGURES

FIG. 1 is an illustration of a browser screen component of a browser.

FIG. 2 is an illustration of a subsequent browser screen.

FIG. 3 is an illustration of a navigation screen.

FIG. 4 is an illustration of a navigation screen.

FIG. 5 is an illustration of a navigation mosaic.

FIG. 6 is an illustration of an information screen.

FIG. 7 illustrates an exemplary list of functions accessible via the remote control.

FIG. 8 illustrates a favorites pop-up window, accessed on the screen in FIG. 2.

FIG. 9 illustrates layers of the computer system and hierarchy.

FIG. 10 illustrates two-directional browser system mapping.

FIG. 11 illustrates system architecture.

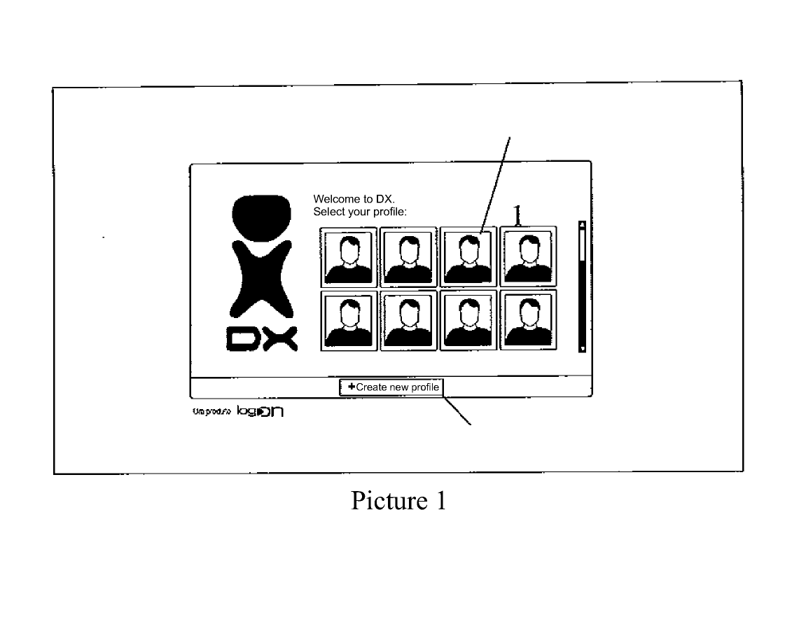

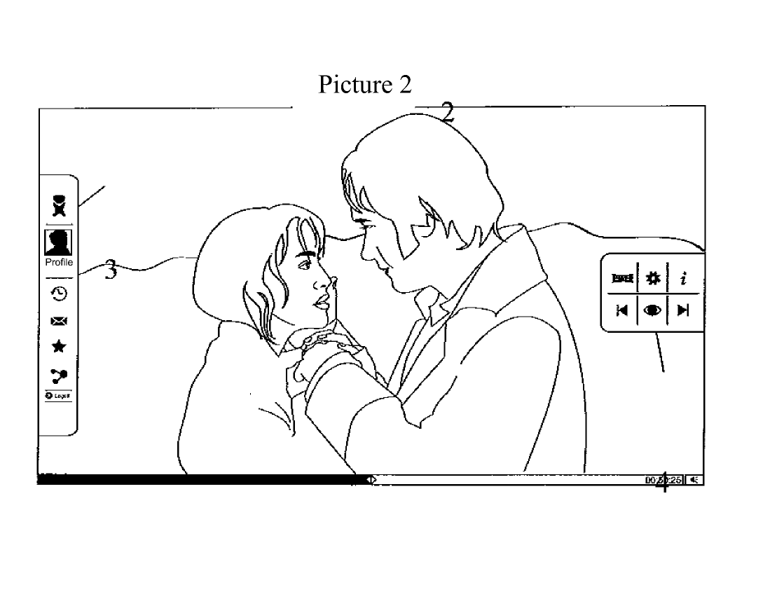

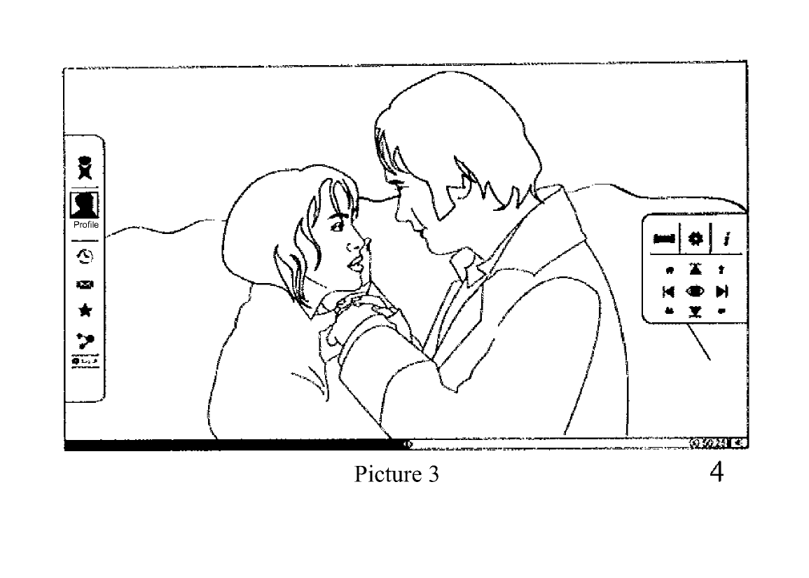

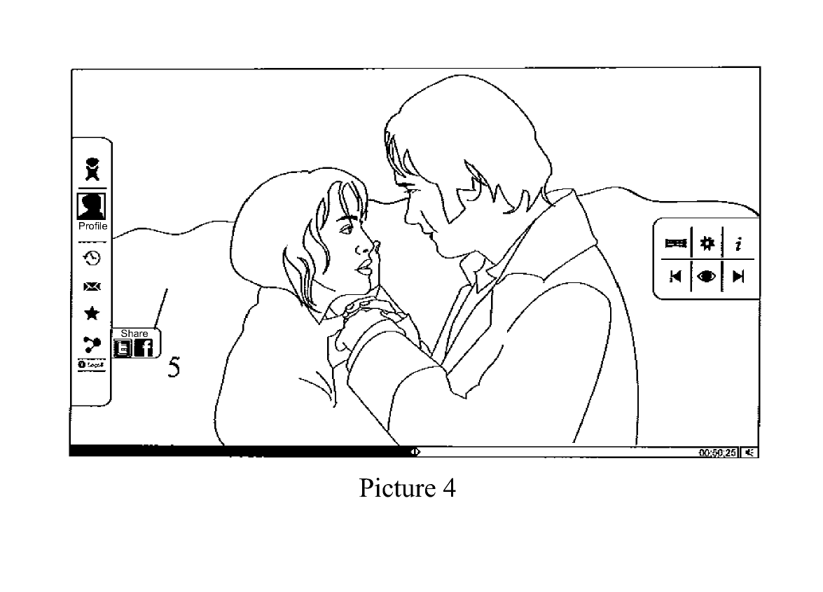

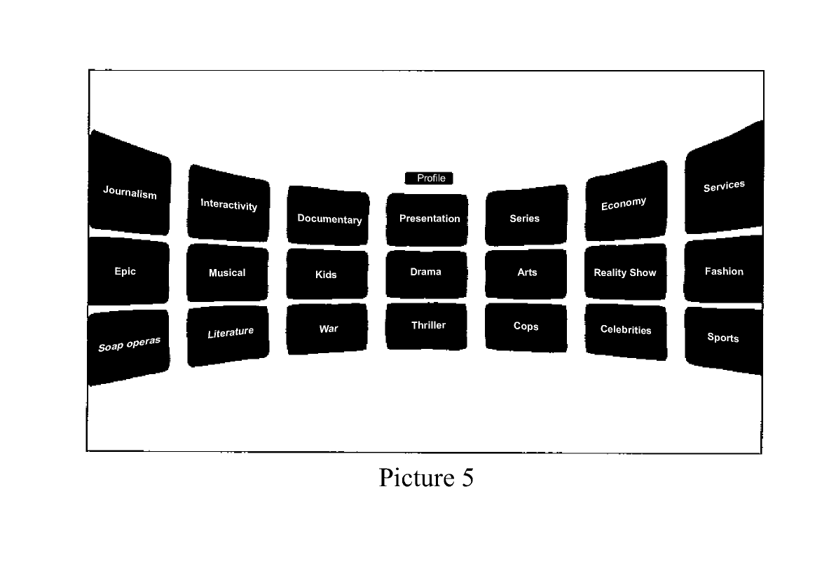

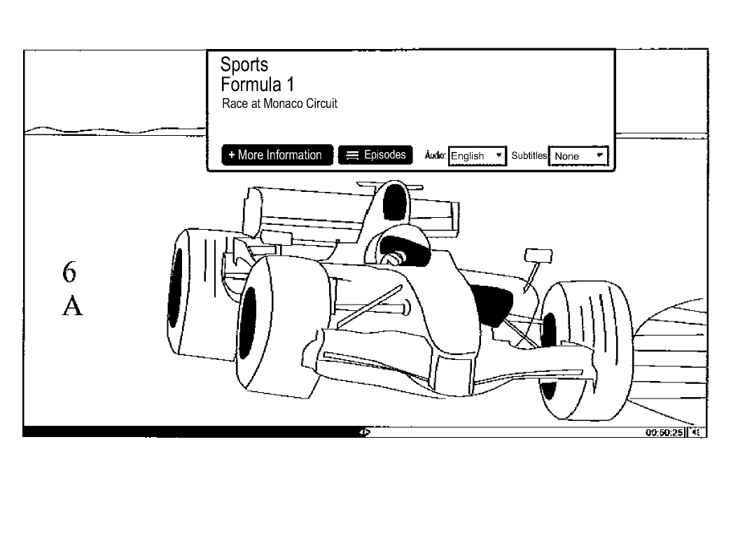

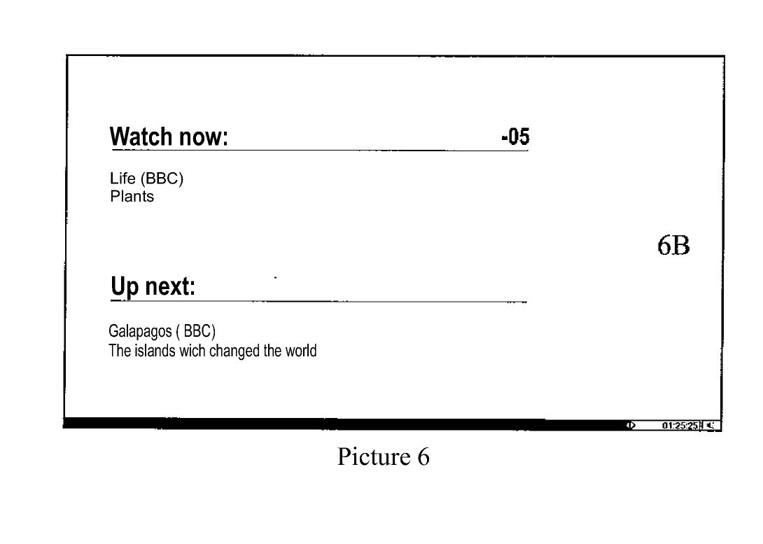

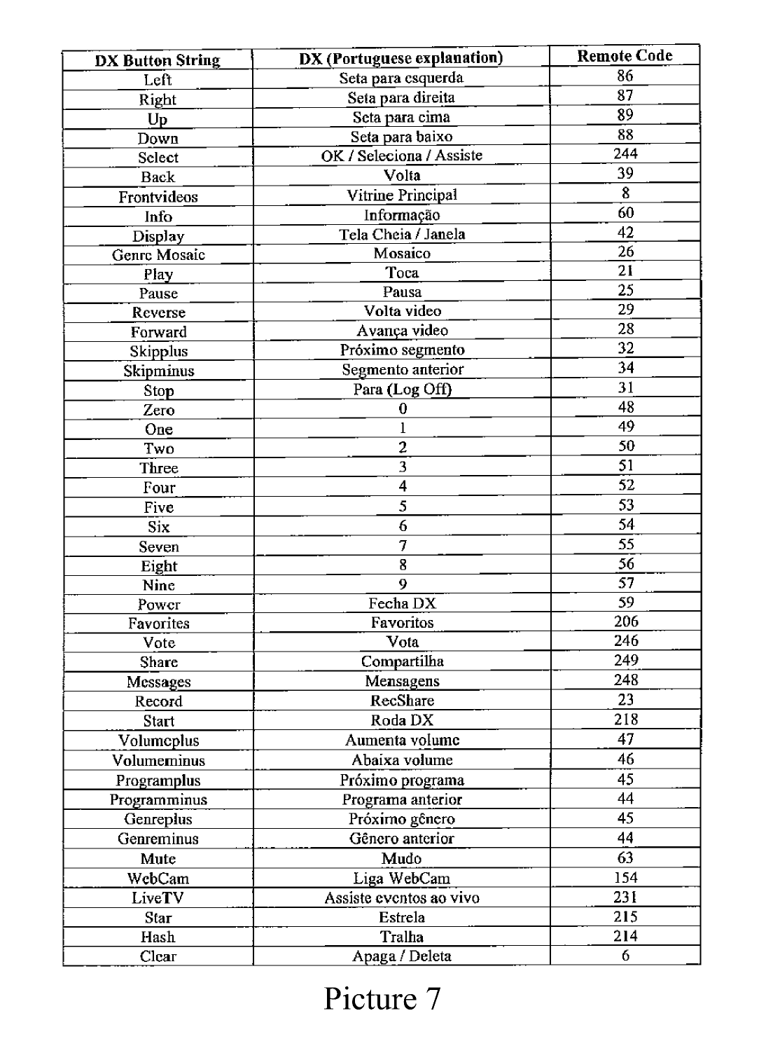

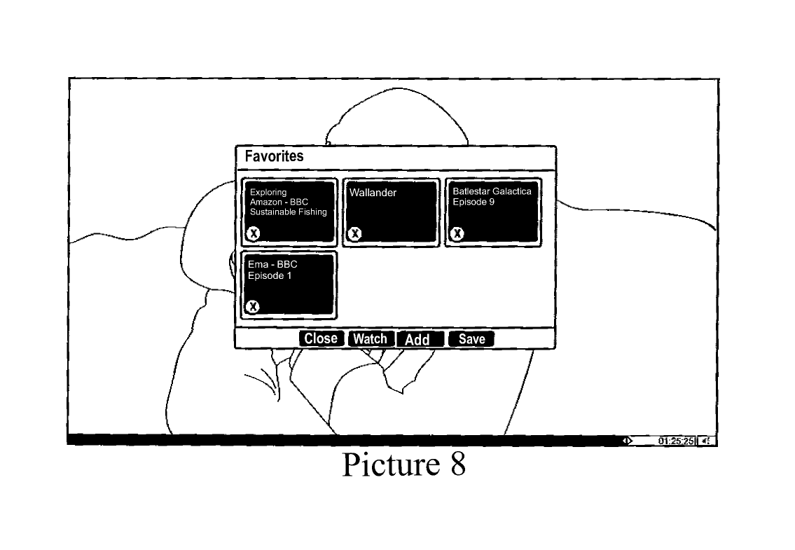

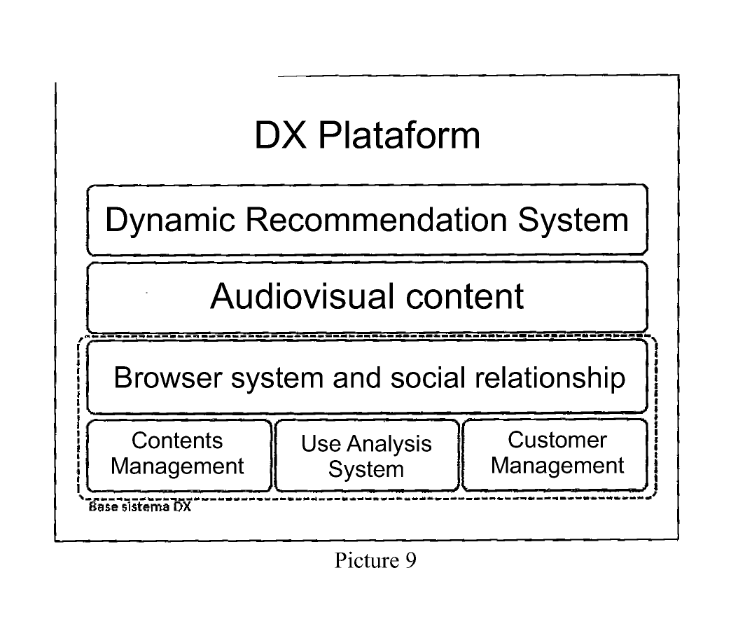

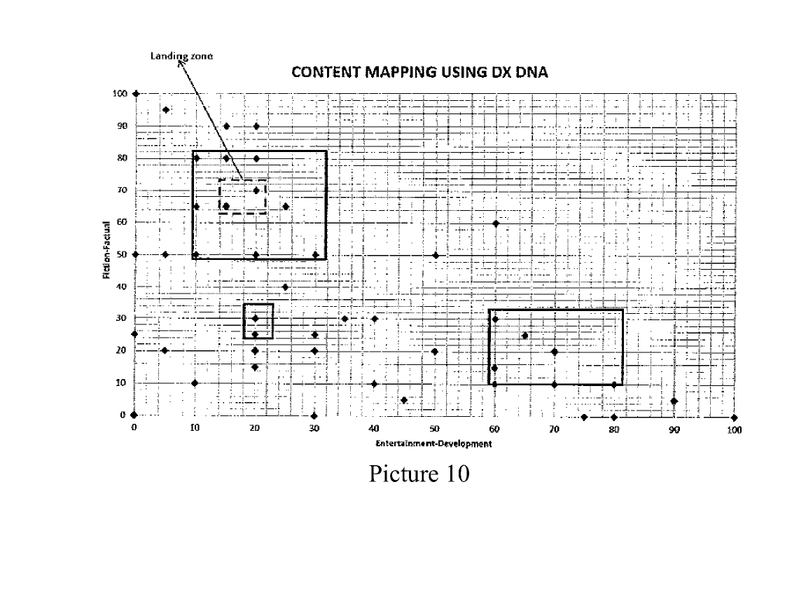

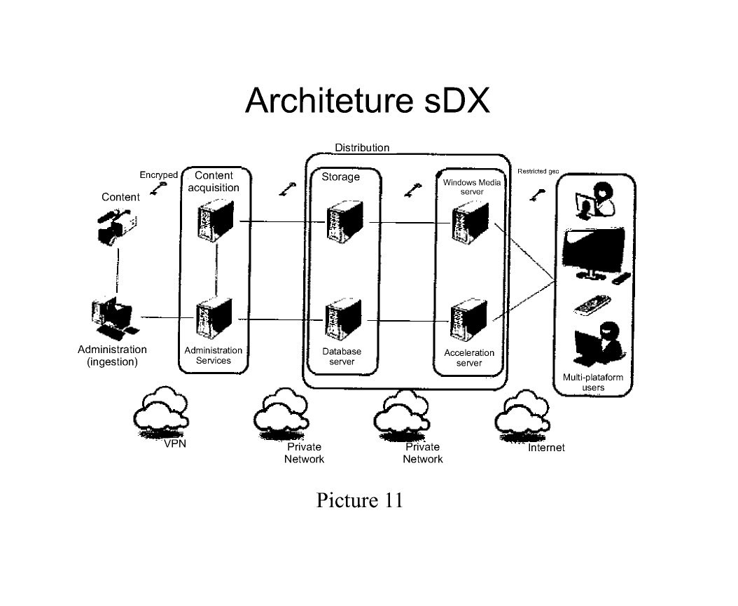

### DESCRIPTION OF THE INVENTION

In order to address the gap in the technique, this invention offers a dynamic visual browser that allows users to watch, browse, navigate and interact with video playlists using unique interactions, while maintaining the video being reproduced, ensuring an individualized, continuous and intuitive experience, emulating the behavior of consumption of television video.

It is also proposed a method associated to touch successively each video, in sequences at an interface in order to see and explore them, retaining preferences, history and interactions generated by the user within the video browser. This method offers custom videos lists for each user creating a unique experience for each consumer of video that can be shared with other users in an open or closed network environment.

Navigation can be two-dimensional, as shown in Picture 3, within a matrix rather than a linear list, or can be hierarchical within a mosaic. Matrices and mosaics may have its composition chosen by the user. Contents can be evaluated by the user using several parameters, including recommendations for number note, matched or not, with personal feelings (sadness, joy, excitement, anger, joy etc.) through of icons which can be shared.

This invention can replace TV systems available today, providing solutions for various markets in any electronic communication device. Taking a common interface, a browser model and a personalized offer and individual audiovisual contents (presentations, videos and games) to any place at any time, at an affordable cost. The proposed invention can be better understood when accompanied by the picture below.

Picture 1 shows the first screen of the browser, with the illustration of each user (1) and the option to create a new user (2). At this point, the user can select a profile previously registered, or register new profiles, according to their preference or convenience.

Picture 2 shows the next screen: the linear navigation where the user can choose, through a series of icons (3), functions (4) such as pause or rewind the content, while the video content is in action.

Picture 3 shows the navigation screen in Freestyle mode, where the user can navigate through the content using a two-dimensional map (5), as the example in Picture 10. Navigation elements are illustrated in Picture 3 with the traditional symbols of movement (up, down, left and right), guiding the user in the map provided or chosen, associated with additional symbols to watch or select the content, enabling functions such as to go back to the initial content; performing linear browsing (as illustrated in Picture 2); share the browser with other people who can watch the content together, in a bonded navigation, called tag-along, where a user is active and the other passive; or perform self-browsing, which all the contents of the system are walked through in an order recommended by the system or chosen by the user.

Picture 4 represents a particular case of Picture 1, where icons representing links to social networks (6), for example, Facebook, can be accessed to share information with other users such as preferences, history and interactions generated by users within the video browser and import friends from social networks in real time.

Picture 5 displays the navigation mosaic, where the user can choose any content by category, gender preference, friends, directors, celebrities, production year, actors, origin, format, or any other data associated with the content, to friends or imported lists from other systems.

Picture 6 shows two pop-up windows containing information about the content. The first (6A) is the Information and Interaction Interface Overlay (called Content Information “Widget”), accessed on the screen in Picture 2 by the icon where the user can get extra information, such as the name of program director, year of production etc., and choose languages and subtitles and also switch to similar contents. Such window also suggests other contents possibilities based on the dynamics of the user mappable dynamics of navigation and their friends and their status for the profile on the Internet. The second (6B) is an informational screen superimposed without interaction with content that shows the next on the list.

Picture 7 displays the list of functions accessed via the remote control, an integral part of the proposed solution.

Picture 8 shows the Favorites Pop-up Window, accessed on screen in Picture 2, where the user can add or access contents taken as their favorites, and they can also be sorted and categorized by the mosaic.

Picture 9 shows the layers of the computer system and hierarchy, which together systematize the browser, where the first layer relates to the “Dynamic Recommendation System”, which deals with data from various sources to give choices to the user, giving different browser recommendations for each user or group of users, at every new request. The recommendation system information can be derived from the use as per categories, content status, period of use, use of friends, two-dimensional axes navigation and popularity, among others.

Picture 10 shows the mapping of the two-directional browser system, with the example of the possible axes of navigation and content mapped relative position of these two-dimensional axes (e.g. ‘Factual-Fiction’ and ‘Entertainment-Development’).

Picture 11 shows the architecture for online distribution of the system that sustains the browser: the storage of contents, data exchange and information management for delivery of audiovisual content. The elements described in this architecture are based on current standards for online distribution of audiovisual content, and is compatible with any device connected to the Internet. The concepts of current invention in offline systems interfaces may also be used (not connected to the internet) compatible with other video devices using different architectures.

In the presentation dynamics, the video is always offered in full screen, where the interface is only displayed when the interaction is requested within the browser, and all content appears always being reproduced (playing), unless paused by the user. The content exchange happens quickly enough to maintain the immersion impression, as in the exchange of TV channels, having the advantage of always getting the content from the beginning, at the time user.

Navigation between audiovisual content within the dynamic presentation is made by a list of videos available, following an individual and not collective logic. Every viewer will have a navigation experience with choices of content and custom browser by users, by friends or by the system.

Linear navigation is similar to TV only that instead of changing channels, the user advances or reverses using video programs that are arranged in playlists, forward or backward on playlists. Navigation can be within a two-dimensional array rather than a linear list (as in Picture 3), or may be within a hierarchical mosaic (as in the video wall in Picture 5). These arrays and mosaics may have its composition chosen by the user, according to their preference.

The interface allows the division of experiences with other users, while watching the video, allowing people to have experiences of browsing choices by shared videos. The navigations and videos viewed previously in other sessions in the browser can be saved and accessed later.

The user can save his favorites or favorite other users for later access, and also share preferences, video segments, and further comment and share with others any action or display of the browser use, at the same device or other devices.

The browser stores the individualized presentation dynamics and offers new content or not, within a logic for each individual user.

Researches done within the browser are made by unique numbers for each program, by genres or any parameter chosen by the user in the configuration.

The interface allows complete control of navigation as a video player, and it is possible to pause, forward and reward within the video. The interface allows the user to access messages sent by them to others users or from other users to them in the form of video messaging, video links, per image or text.

The video browser can be used in any electronic device that displays audiovisual content on a screen with a frequency rate higher than 15 frames per second and having access to content on a sustained form greater than or equal to the playback speed of videos. These devices include computers, cell phones, TV and network access monitors, portable video players, and any other video player devices. The command of these executions may be through an input device such as a touch screen, a keyboard, a pointer (mouse) or a remote control.

This invention is not limited to representations commented or illustrated herein and should be understood in its wide scope. Many modifications and other representations of the invention will come to mind for those well versed in the technique to which this invention pertains, having the benefit of the teachings presented in the foregoing descriptions and drawings attached. Moreover, it is to be understood that the invention is not limited to the specific form disclosed, and modifications and other forms are understood as included within the scope of the appended claims. Although specific terms are employed here, they are only used in a generic and descriptive purpose and not as limitators.

1. A dynamic audiovisual browser for use on a computer comprising computer-executable instructions that, when executed, allow users to watch, search, browser and interact with video playback playlists while maintaining the videos being reproduced, emulating the behavior of consumption of television content, equipped with the following screens that determine their visual characteristics and functions:
Home screen, where the user can select a profile previously registered or register new profiles;
Linear navigation screen whereby the user can choose playback functions while concomitantly video content is in action;
Freestyle navigation screen where the user can browse through a playlist using a two-dimensional map;
Screen navigation by mosaic, where the user can choose playlist contents per all categories, including one or more of genres, friends, directors, celebrities, year of production, actors, country of production, format, and any other data associated therewith; and
Display information about the content where the user can obtain extra information including one or more of the name of the program director, year of production, and choose languages and subtitles, switch to similar content, and suggest other possibilities for contents based on user user-mappable dynamics from browsing history and from the profile;
Informational screen without interaction, overlapped to the content that shows the next on the list; and
‘Favorites’ screen, where the user can add content or access user-favorite contents.

2. A dynamic recommendation system comprising a computer configured for playing successively each video in sequences, retaining preferences, history and interactions generated by the user within the browser and for treating statistically the data obtained by each user's browsing, recommending different contents for each user or group of users, at every new request, where the information of the recommendation system is obtained by access to the categories, to the status of contents, by hours of use, use of friends, two-dimensional browsing axis, popularity or any other browsing features, providing custom lists of videos for each user, which can be shared with other users in a network environment, whether open or closed.

3. A non-transitory computer-readable medium having computer-executable instructions stored thereon for rendering a dynamic audiovisual browser on a computer display, said instructions, when executed by a computer, enabling user interaction via the browser to allow users to navigate video playback playlists while maintaining the videos being reproduced and emulating a user experience similar to the consumption of television content, said user experience including rendering one or more of the following displays to the user:
a home screen for selecting a profile previously registered or for registering a new profile;
a linear navigation screen for presenting at least one playback control;
a freestyle navigation screen for browsing contents using a two-dimensional map;
a mosaic navigation screen for browsing contents per all categories;
an information display screen presenting information about selected content; and
a favorites screen for accessing and managing user-favorite contents.
